(19) United States
(12) Patent Application Publication
(10) Pub. No.: US 2022/0064019 A1
(43) Pub. Date: Mar. 3, 2022

(54) Alternative One-Pot Process for Making a Cam Precursor Using Metal Feedstocks

(71) Applicant: Nano One Materials Corp., Burnaby (CA)

(72) Inventors: Stephen A. Campbell, Burnaby (CA); Thomas E. Rowe, Burnaby (CA)

(73) Assignee: Nano One Materials Corp.

(21) Appl. No.: 17/412,994

(22) Filed: Aug. 26, 2021

Related U.S. Application Data
(60) Provisional application No. 63/074,025, filed on Sep. 3, 2020.
(60) Provisional application No. 63/161,644, filed on Mar. 16, 2021.

(51) Int. Cl. C01G 53/00; H01M 10/0525

(52) U.S. Cl. CPC C01G 53/54; C01P 2002/32; H01M 10/0525

(57) ABSTRACT

The present invention provides a method for forming a lithium ion cathode material. The method comprises reacting elemental metal with a multi-carboxylic acid to form an oxide precursor and heating the oxide precursor to form the lithium ion cathode material. In a preferred embodiment the elemental mixture comprises at least two of Ni, Mn, Co and Al.

### CROSS-REFERENCE TO RELATED APPLICATIONS

This application claims priority to pending U.S. Provisional Patent Application No. 63/074,025 filed Sep. 3, 2020 and to U.S. Provisional Patent Application No. 63/161,644 filed Mar. 16, 2021 both of which are incorporated herein by reference.

### BACKGROUND

The present invention is related to an improved method of forming fine and ultrafine powders and nanopowders of cathode active materials (CAM) for batteries. More specifically, the present invention is related to, but not limited to, lithium ion battery cathodes and an efficient method of preparing the CAMs with a minimal waste of material and a reduction in the number of process steps some of which are detrimental to sintering and calcining.

There is an ever-present demand for improvements in batteries. There are two primary applications for batteries with one being stationary applications and the other being mobile applications. With both stationary and mobile applications there is a desire for increased storage capacity, longer battery life, the ability to reach full charge quicker and lower cost. Lithium ion batteries, comprising a lithium metal oxide cathode as the CAM, are highly advantageous as a suitable battery for most applications and they have found favor across the spectrum of applications. Still, there is a desire for an improvement in, particularly, the storage capability, recharge time, cost and storage stability of lithium ion batteries.

The preparation of lithium ion batteries comprising lithium and transition metal based cathodes in a rock-salt crystalline form are described in U.S. Pat. Nos. 9,136,534; 9,159,999 and 9,478,807 and U.S. Published Pat. Appl. Nos. 2014/0271413; 2014/0272568 and 2014/0272580 each of which are incorporated herein by reference. Cathode materials having a rock-salt crystalline form have general formula:

LiNiₐMn_{b}X_{c}O₂

wherein X is preferably Co or Al and a+b+c=1. When X is cobalt the cathode materials are referred to as NMC's, for convenience, and when X is aluminum the cathode materials are referred to as NCA's, for convenience.

Cathode materials having the spinel crystalline structure have general formula:

LiNiₓMn_{y}Co_{z}O₄

wherein x+y+z=2.

In a recently reported advance the CAM, either rock-salt or spinel, is formed by the digestion of metal carbonates in oxalic acid with Li₂CO₃ to make a mixed oxalate precursor. The mixed oxalate precursor is then calcined to make the CAM. The supply chain for transition metal carbonates is not well established since the supply chain is primarily based on the formation of metal sulfates.

Metal carbonates are typically made from metal sulfates. Metal sulfates are very low in metal content, 21 wt % for nickel for example, and therefore the cost associated with formation of metal carbonates from metal sulfates significantly mitigates the cost efficiencies associated with the oxalate process discussed above. In the formation of the metal sulfate the transition metals are extracted from the original source, often purified as metals, and then redissolved as acids. Therefore, the formation of metal carbonates, from metal sulfates, creates a Na₂SO₄ waste stream and the purity would typically be insufficient for use in the formation of CAMs for battery production unless additional, expensive, purification steps are utilized.

There has been a desire for an improved method of manufacturing lithium ion cathodes and particularly lithium/manganese/nickel based cathodes in spinel and rock salt crystalline structures which is not encumbered by the precursor supply issues and waste stream issues common in the art. The present invention provides such a method.

### SUMMARY OF THE INVENTION

It is an object of this invention to provide an improved method of preparing a CAM for lithium ion batteries.

More specifically, the present invention is related to improvements in the formation of precursors for CAM which eliminates the necessity of forming the metal sulfate and therefore eliminates the need of converting the metal sulfate to metal carbonate which streamlines the metal precursor production.

It is an object of the invention to provide an improved method for forming metal salt precursors of a lithium metal oxide wherein the metal salt precursors are calcined to form the lithium metal oxide cathode.

It is a particular object of the invention to provide an improved method for forming lithium ion batteries comprising a transition metal-based cathode in a spinel crystalline structure or a rock-salt structure preferably chosen from NMC and NCA.

A particular advantage of the instant invention is in the ability to form high nickel CAMs wherein the precursor materials have been particularly difficult to obtain at a cost and purity level suitable for the formation of high nickel CAMs.

An embodiment of the invention is provided in a method of forming a lithium ion cathode material. The method comprises reacting elemental metal with a multi-carboxylic acid to form an oxide precursor and heating the oxide precursor to form the lithium ion cathode material. In a preferred embodiment the elemental mixture comprises at least two of Ni, Mn, Co and Al.

An embodiment of the invention is provided in a method of forming a lithium ion cathode material comprising:

reacting element nickel with nitric acid to form nickel nitrate;
reacting the nickel nitrate with a multi-carboxylic acid to form an oxide precursor; and heating the oxide precursor to form the lithium ion cathode material.

### BRIEF DESCRIPTION OF THE DRAWINGS

FIG. 1 is an XRD scan of control and inventive examples.

FIG. 2 is a graphical illustration of half cell data for a control and inventive sample.

FIG. 3 is an XRD scan of control and inventive examples.

FIG. 4 is an XRD scan of control and inventive examples.

FIGS. 5 and 6 are graphical illustrations of half cell data for a control and inventive sample.

FIG. 7 is an XRD scan of control and inventive examples.

FIG. 8 is a graphical illustration of half cell data for a control and inventive sample.

### DESCRIPTION

The instant invention is specific to an improved method for preparing a lithium ion battery, and particularly the CAM of a lithium ion battery. More particularly, the present invention is specific to an improved process for forming cathodes for use in a lithium ion battery wherein the cathode is in a spinel crystalline form or a rock-salt form with preferred rock salt forms being NMC and NCA materials. Even more specifically, the present invention is directed to the formation of metal salt precursors, from elemental metal, directly without the requirement for the formation of sulfates and carbonates.

In a preferred embodiment the CAM of the instant invention comprises a lithium metal compound in a spinel crystal structure defined by the Formula I:

LiNiₓMn_{y}Co_{z}E_{w}O₄ Formula I

wherein E is an optional dopant; and
x+y+z+w=2 and w≤0.2; or
a rock-salt crystal structure defined by Formula II;

LiNiₐMn_{b}X_{c}G_{d}O₂ Formula II

wherein G is an optional dopant;

### X is Co or Al; and

wherein a+b+c+d=1 and d≤0.1.

In a preferred embodiment the spinel crystal structure of Formula I has 0.5≤x≤0.6; 1.4≤y≤1.5 and z≤0.9. More preferably 0.5×0.55, 1.45≤y≤1.5 and z≤0.05. In a preferred embodiment neither x nor y is zero. In Formula I it is preferable that the Mn/Ni ratio is no more than 3, preferably at least 2.33 to less than 3 and most preferably at least 2.6 to less than 3.

In a preferred embodiment the rock-salt crystal structure of Formula II is a high nickel NMC wherein 0.5≤a≤0.9 and more preferably 0.58≤a≤0.62 as represented by NMC 622 or 0.78≤a≤0.82 as represented by NMC 811. In a preferred embodiment a=b=c as represented by NMC 111. The term NMCxxx is a shorthand notation used in the art to represent the nominal relative ratio of nickel, manganese and cobalt. NMC811, for example, represents LiNi_{0.8}Mn_{0.1}X_{0.1}O₂.

In the formulas throughout the specification, the lithium is defined stoichiometrically to balance charge with the understanding that the lithium is mobile between the anode and cathode. Therefore, at any given time the cathode may be relatively lithium rich or relatively lithium depleted. In a lithium depleted cathode the lithium will be below stoichiometric balance and upon discharging the lithium may be above stoichiometric balance. Likewise, in formulations listed throughout the specification the metals are represented in charge balance with the understanding that the metal may be slightly rich or slightly depleted, as determined by elemental analysis, due to the inability to formulate a perfectly balanced stoichiometry in practice.

Dopants can be added to enhance the properties of the oxide such as electronic conductivity and stability. The dopant is preferably a substitutional dopant added in concert with the primary nickel, manganese and optional cobalt or aluminum. The dopant preferably represents no more than 10 mole % and preferably no more than 5 mole % of the oxide. Preferred dopants include Al, Gd, Ti, Zr, Mg, Ca, Sr, Ba, Mg, Cr, Cu, Fe, Zn, V, Bi, Nb and B with Al and Gd being particularly preferred. Dopants and coating materials may be added to the reactor either as carbonates, oxides or metals as appropriate to make the desired composition.

The cathode is formed from an oxide precursor comprising salts of Li, Ni, Mn, Co, Al or Fe as will be more fully described herein. The oxide precursor is calcined to form the cathode material as a lithium metal oxide. The cathode material is optionally treated with a phosphate salt, XPO₄, wherein X is the atoms necessary to balance the charge and X may be a monovalent atom, a divalent atom or a trivalent with the understanding that combinations may be used as desired. It is particularly preferred that X be easily removed either by washing or vaporization after application. The phosphate salt is applied to the surface of the metal oxide wherein the phosphate moiety forms MnPO₄ on the surface of the metal oxide, or is bonded to the surface of the metal oxide. The manganese is preferably predominantly in the +3 oxidation state with preferably less than 10% of the surface manganese being in the +2 oxidation state and the manganese thereby stabilized against reduction to Mn²⁺ at the surface. The reaction liberates X which is removed by washing or vaporization. In preferred phosphates, X is selected from NH₄⁺, H⁺, Li⁺, Na⁺, and combinations thereof. Particularly preferred phosphates include (NH₄)₃PO₄, (NH₄)₂HPO₄, (NH₄)H₂PO₄, and H₃PO₄ due to the ease of removal of X after formation of the surface manganese phosphate. It is preferred that the native manganese oxide of the calcined oxide precursor be reacted with phosphate as opposed to an added manganese or other metal. Therefore, it is preferred that the added phosphate be relatively free of Mn and more preferably less than 1 wt % manganese. It is preferable that no Mn⁺² be added with the phosphate or after formation of the oxide. It is preferable that there be no separate manganese phosphate phase such as manganese phosphate as a distinct phase on the surface. It is preferable that the phosphate ligate the surface of the metal oxide.

The oxide precursors are formed by reacting multi-carboxylic acids, preferably oxalic acid, with elemental metal powders to form insoluble salts without having to first form a sulfate salt or carbonate salt. The reaction rate of Co with multi-carboxylic acids is faster than Mn which is faster than Ni. In the process of making the precursor the metal powders are added to a saturated suspension of multi-carboxylic acids, preferably oxalic acid, resulting in the liberation of H_{2(g)} and the precipitation of metal salt with metal oxalate being exemplary of the metal multi-carboxylic acids. A particular advantage is that the, preferably oxalic, acid does not need to be completely dissolved at room temperature and therefore the amount of solvent, preferably water, required for the reaction can remain quite low which minimizes the energy required for removal of the water.

During the reaction of metal powder and multi-carboxylic acids the reactor may be stirred or agitated to ensure continued reaction. Alternatively, the reaction may be accomplished in a horizontal bead-mill to increase the reaction rate. It is preferable to heat the metal powder and multi-carboxylic acids to increase the reaction rate. The reaction will proceed at low temperature, such as 10° C., however slow reaction rate is undesirable. The reaction can be heated to over 100° C. however, since water is a preferred solvent it is preferable not to exceed 100° C. unless a reflux system is employed. The water may be replaced with an azeotropic mixture of water and alcohols which reduces the cost of drying. An exemplary azeotrope is 87.7 wt % propan-2-ol which boils at 80.4° C. without limit thereto.

The reaction may also be heated to above 100° C. either directly or partly through the bead-milling process. The reaction may be done in a reactor such as a horizontal ball mill using ZrO₂ balls or a bead mill using ZrO₂ beads. Alternatively, the reaction may take place in an autoclave so that temperatures above 100° C. may be used such as up to 200° C.

The time of addition of Li₂CO₃ is not particularly critical. If Li₂CO₃ is added early in the process lithium salts, such as lithium oxalate, are formed by digestion of the carbonate and the lithium salt remains. Alternatively, the Li₂CO₃ can be added after the transition metal reaction is complete. The metals are oxidized by the acidic proton thereby producing H₂ gas which is preferably handled in a manner consistent with conventional laboratory or manufacturing practice. In one embodiment the reactor may be under inert gas, such as N₂ or He, or the vessel may be actively vented to avoid the risk of explosion.

The reaction time is dependent on temperature and agitation, however, the reaction is allowed to continue until completion which is indicated by a colour change in the slurry or in the stabilization of the slurry pH. Following this step, the slurry must be dried, such as by spray drying or drum drying, followed by calcining as usual in air and/or O₂ depending upon the final formulation of the CAM.

In a preferred embodiment, the metal powder is mixed in the intended ratios in the ultimate CAM. By way of non-limiting example, if LiNi_{0.8}Mn_{0.1}Co_{0.1}O₂ is to be prepared the metal powder would have 8 molar parts Ni, 1 molar part Mn and 1 molar part Co with one molar part Li added prior to calcining. The elemental metal feedstock particle size may be adjusted so that the elemental metals react at similar rate. By way of non-limiting example, the particle size may be inversely related to the reaction rate such that the surface area increase mitigates the difference in reaction rate. Since the reaction rate follows the relationship Co>Mn>Ni it may be advantageous to utilize particle size differences which follow the same relationship.

Sulfur concentration, as an impurity, is particularly important for nickel wherein higher sulfur concentrations increase the reaction rate. It would be understood to those in the art that sulfur is undesirable for electrical performance and therefore sulfur is typically to be avoided, or below detectable limits. However, a small level of impurity may be acceptable to balance the reaction rate with electrical performance. A sulfur impurity of no more than 0.05 wt %, relative to nickel metal, can be effective at sufficiently increasing the reaction rate with the carbonate without significant decrease in electrical performance.

The reaction rate of nickel can be enhanced by the introduction of nitric acid prior to the introduction of the carbonate.

In a particularly preferred embodiment Ni powder is first dissolved in nitric acid and allowed to cool to ambient temperature to form a nickel nitrate solution. A molar quantity of multi-carboxylic acid, preferably oxalic acid, is dispersed in water and, while stirring, the nickel nitrate solution is slowly added to the multi-carboxylic acid suspension forming a nickel, preferably oxalate, precipitate the completion of which is indicated by the absence of green supernatant solution. Then the required amounts of Li₂CO₃ with Mn metal powder, Co metal powder and doping and coating materials, dispersed in water, slowly added to the Ni slurry while stirring until reaction is complete. The slurry is then spray dried and calcined as usual.

Divalent metal oxalates such as NiC₂O₄, MnC₂O₄, CoC₂O₄, ZnC₂O₄, etc. are highly insoluble, however monovalent metal oxalates such as Li₂C₂O₄ are somewhat soluble with a solubility of 8 g/100 mL at 25° C. in water. If it is necessary to have the lithium oxalate in solution and homogeneously dispersed throughout a mixed metal oxalate precipitate, then keeping the water volume above the solubility limit of lithium oxalate may be desirable.

Multi-carboxylic acids comprise at least two carboxyl groups. A particularly preferred multi-carboxylic acid is oxalic acid due, in part, to the minimization of carbon which must be removed during calcining. Other low molecular weight di-carboxylic acids can be used such as malonic acid, succinic acid, glutaric acid and adipic acid. Higher molecular weight di-carboxylic acids can be use, particularly with an even number of carbons which have a higher solubility, however the necessity of removing additional carbons and decreased solubility renders them less desirable. Other acids such as citric, lactic, oxaloacetic, fumaric, maleic and other polycarboxylic acids can be utilized with the proviso they have sufficient solubility to achieve at least a small stoichiometric excess and have sufficient chelating properties. It is preferable that acids with hydroxyl groups not be used due to their increased hygroscopic characteristics.

The dried powders may be transferred into the calcining system batch-wise or by means of a conveyor belt. In large scale production, this transfer may be continuous or batch. The calcining system may be a box furnace utilizing ceramic trays or saggers as containers, a rotary calciner, a fluidized bed, which may be co-current or counter-current, a rotary tube furnace and other similar equipment without limit thereto.

The heating rate and cooling rate during calcinations depend on the type of final product desired. Generally, a heating rate of about 5° C. per minute is preferred but the usual industrial heating rates are also applicable.

The final powder obtained after the calcining step is a fine, ultrafine or nanosize powder that may not require additional crushing, grinding or milling as is currently done in conventional processing. Particles are relatively soft and not sintered as in conventional processing.

The final calcined oxide powder is preferably characterized for surface area, particle size by electron microscopy, porosity, chemical analyses of the elements and also the performance tests required by the preferred specialized application.

The spray dried oxide precursor is preferably very fine and nanosize.

A modification of the spray dryer collector such that an outlet valve opens and closes as the spray powder is transferred to the calciner can be implemented. Batchwise, the spray dried powder in the collector can be transferred into trays or saggers and moved into a calciner. A rotary calciner or fluidized bed calciner can be used to demonstrate the invention. The calcination temperature is determined by the composition of the powder and the final phase purity desired. For most oxide type powders, the calcination temperatures range from as low as 400° C. to slightly higher than 1000° C. After calcination, the powders are sieved as these are soft and not sintered. The calcined oxide does not require long milling times nor classifying to obtain narrow particle size distribution.

The LiM₂O₄ spinel oxide has a preferred crystallite size of 1-5 μm. The LiMO₂ rock salt oxide has a preferred crystallite size of about 50-250 nm and more preferably about 150-200 nm.

A particular advantage of the present invention is the formation of metal chelates of multi-carboxylic acids as opposed to acetates. Acetates function as a combustion fuel during subsequent calcining of the oxide precursor and additional oxygen is required for adequate combustion. Lower molecular weight multi-carboxylic acids, particularly lower molecular weight dicarboxylic acids, and more particularly oxalic acid, decompose at lower temperatures without the introduction of additional oxygen. The oxalates, for example, decompose at about 300° C., without additional oxygen, thereby allowing for more accurate control of the calcining temperature. This may allow for reduced firing temperatures thereby facilitating the formation of disordered Fd3̅m spinel crystalline structures with minimal impurity phase occurring as seen at high temperature

The process is easily scalable for large scale manufacturing using presently available equipment and/or innovations of the present industrial equipment.

### EXAMPLES

### Representative Electrode Preparations:

Composite electrodes would be prepared by mixing the active material with 10 wt % conductive carbon black, as a conductive additive, 5 wt % polyvinylidene fluoride (PVDF), as a binder, dissolved in N-methyl-2-pyrrolidinone (NMP) solvent. The slurry would be cast on graphite-coated aluminum foil and dried overnight at 60° C. under vacuum. Electrode disks with an area of 1.54 cm² would be cut form the electrode sheets with a typical loading of 4 mg·cm⁻².

### Representative Coin Cell Assembly:

Coin cells would be assembled in an argon-filled glovebox. Lithium foil (340 μm) would be used as counter and reference electrodes in half-cells, and commercial Li₄Ti₅O₁₂ (LTO) composite electrodes would be used as counter and reference electrodes in full-cells. 1 M LiPF₆ in 7:3 (vol %) ethylene carbonate (EC):diethylene carbonate (DEC) would be used as the electrolyte. The electrodes would be separated by one or two 25 μm thick sheets of Celgard® membranes in half-cells, and one sheet of Celgard membrane full-cells.

### Representative Cycling Protocol:

The spinel cathode cells would be galvanostatically cycled in the voltage range of 3.5 V-4.9 V at various C-rates (1 C rate equivalent to 146 mAg⁻¹) at 25° C., using an Arbin Instrument battery tester (model number BT 2000). A constant voltage charging step at 4.9 V for 10 minutes would be applied to the cells at the end of 1 C or higher rate galvanostatic charging steps. The rock-salt NMC cells would be galvanostatically cycled in the voltage range of 2.7 V-4.35 V at various C-rates (1 C rate equivalent to 200 mAg⁻¹) at 25° C. A constant voltage charging step at 4.35 V for 10 minutes would be applied to the cells at the end of 1 C or higher rate galvanostatic charging step.

### Representative Example for NMC811:

16.163 g Li₂CO₃ and 84.110 g oxalic acid dihydrate were added slowly to 250 ml deionized water in a beaker and the mixture was heated to 70° C. while stirring. 19.564 g Ni powder, 2.291 g Mn powder and 2.458 g Co powder were physically mixed together. Once a clear solution was at temperature, the metal powder mixture was added to the beaker and stirring was continued as the metals reacted.

When all the metals have finished reacting, the resultant slurry was dried using a Büchi benchtop spray dryer to produce a complete precursor powder. The precursor was placed in alumina saggars and fired in an oxygen flow in the following way. Heat from ambient to 120° C. in 20 minutes and hold at that temperature for 1 hour. Heat to 860° C. in 142 minutes and hold for 15 hours. Cool to 550° C. in 60 minutes and then to 120° C. in 3 hours. Allow passive cooling to <100° C. when the sample is removed, ground and passed through a 325 mesh sieve before vacuum packing in a metallized polymer bag.

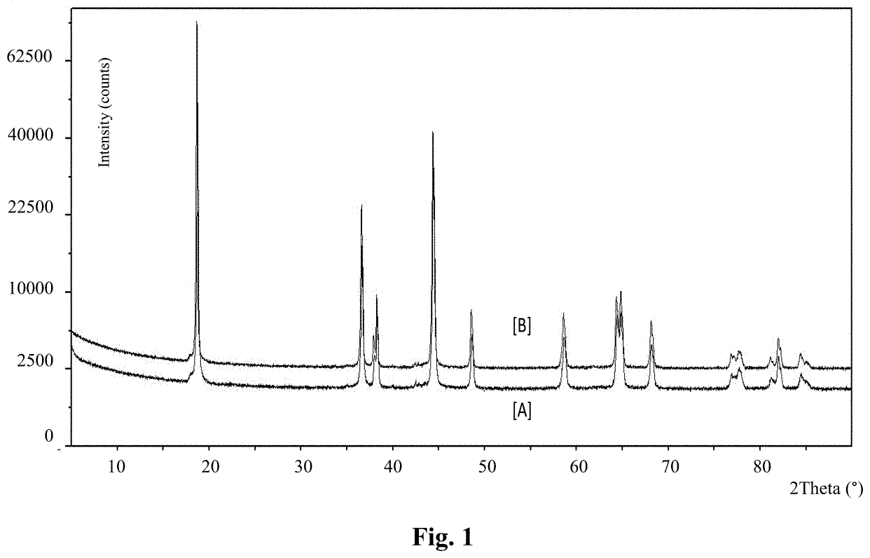

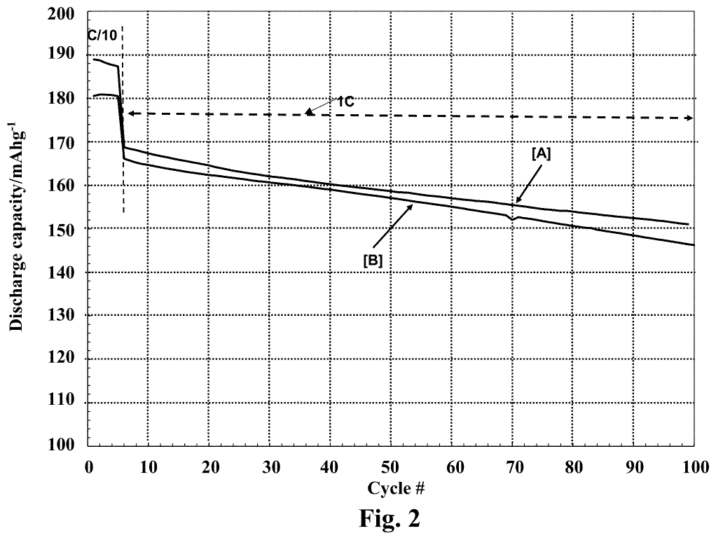

The x-ray diffraction (XRD) pattern matched that for NMC 811 made using carbonates as the transition metal feedstocks as shown in FIG. 1. In FIG. 1 the XRD pattern for NMC 811 made directly with transition metal powders is illustrated as scan A and the XRD pattern for NMC 811 made with carbonates is illustrated as scan B. In both cases lithium carbonate was the lithium source. The half-cell data from a 2032 coin of the samples is illustrated graphically in FIG. 2.

### Formation Using Nitrate Precursor

The Ni powder is first dissolved in 9M nitric acid and allowed to cool to ambient temperature. The required oxalic acid is dispersed in water and, while stirring, the nickel nitrate solution is slowly added to the oxalic acid suspension and the nickel oxalate precipitation proceeds until there is no green supernatant solution. Then the required amounts of Li₂CO₃ with Mn, Co, metal powders doping and coating materials, dispersed in water, are slowly added to the Ni oxalate slurry while stirring and left to react with the acid until reaction is complete.

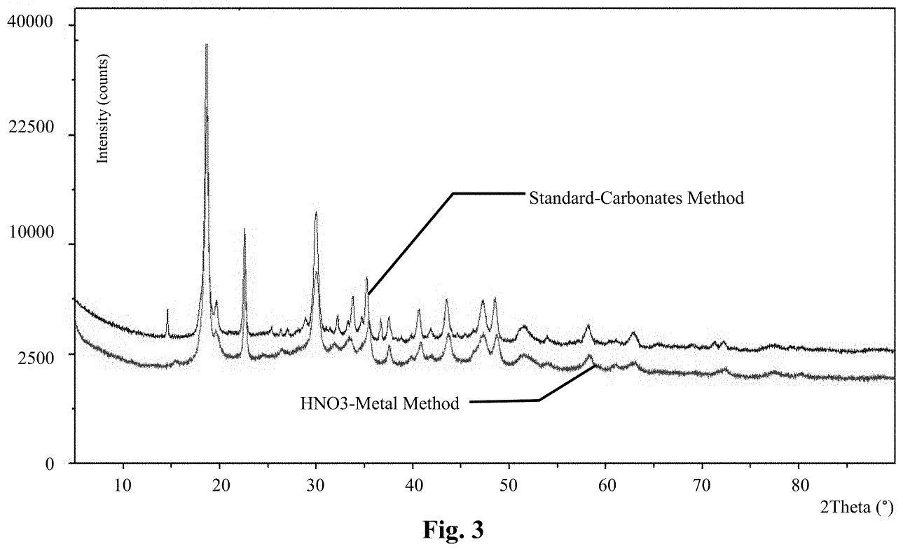

FIG. 3 shows the X-ray diffractograms of oxalates produced from the carbonate method as a control (blue) and the inventive method involving the initial formation of nickel nitrate (red). The peak locations align with a few exceptions which can be accounted for by the lower pH of the reaction mixture which influences the relative proportions of Li₂HC₂O₄ and Li₂C₂O₄ in the solid oxalate powder.

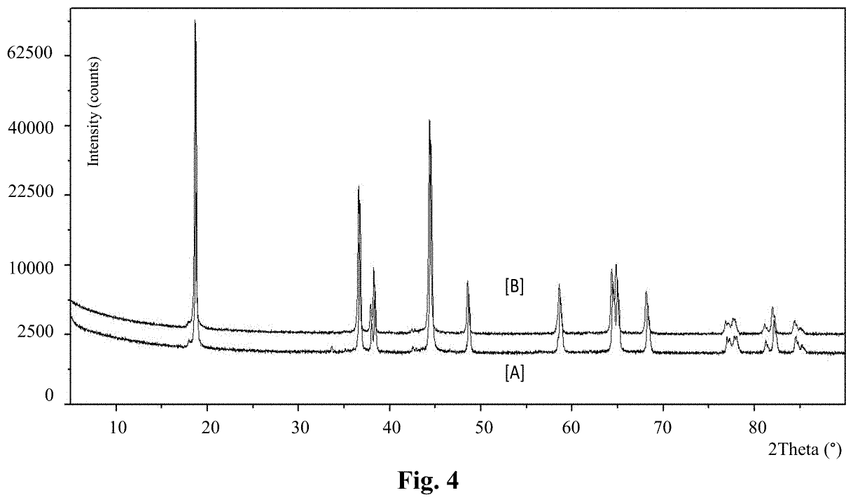

After calcination of the oxalate solids, NMC811 is produced as seen in the X-ray diffractograms shown in FIG. 4. The pattern of peaks produced by NMC811 produced by the HNO₃-metal method (red) and the standard-carbonates method (blue) agree very closely in location and intensity to each other and to reference patterns indicating that the material has a single phase and is NMC811. The targeted 8:1:1 ratio of Ni:Mn:Co is further corroborated by the atomic absorption data presented in Table 1 wherein the metal content is expressed as normalized to the total amount of transition metals present.

TABLE 1

| Sample | Li | Ni | Mn | Co |
|---|---|---|---|---|
| From Metal | 0.9855 | 0.8133 | 0.0938 | 0.0929 |
| Carbonate | | | | |
| From Nickel | 1.150 | 0.7920 | 0.1030 | 0.1050 |
| Nitrate | | | | |

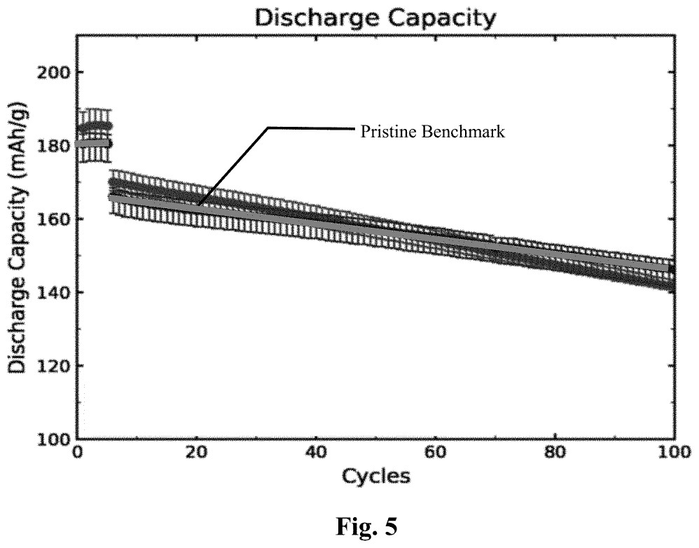

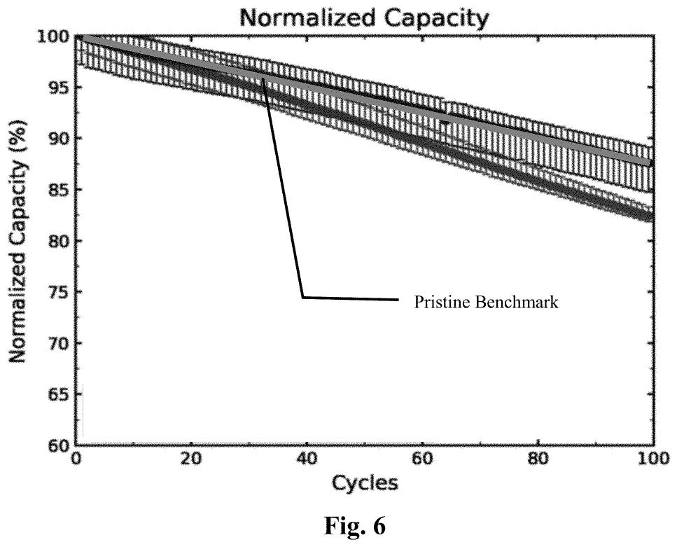

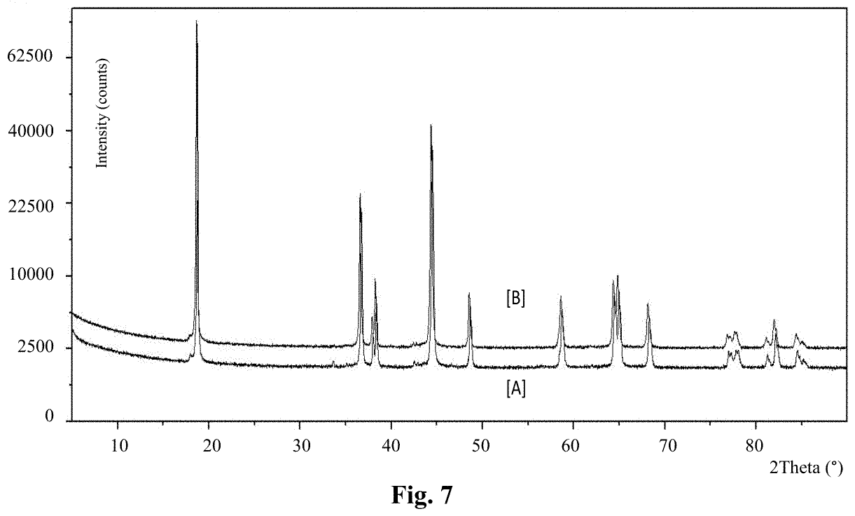

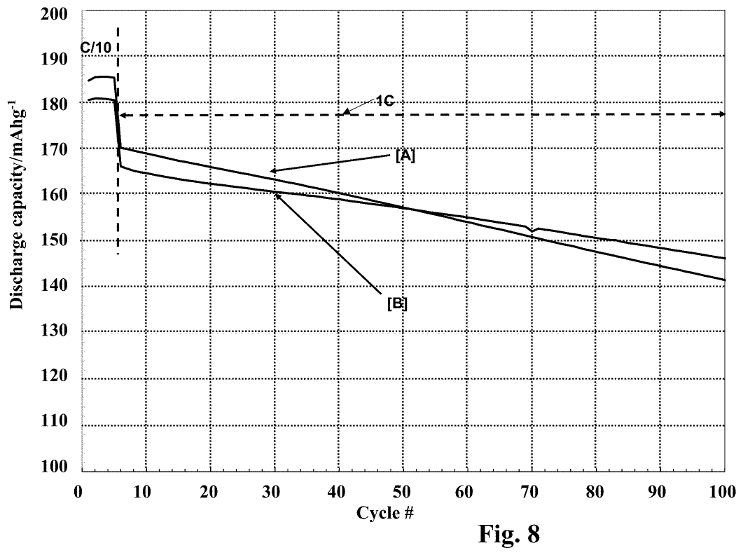

The NMC811 from both methods was tested in half-cell coin cells by conditioning for five cycles at C/10 and then either cycled at 1 C for 100 cycles or subjected to a series of higher charging rates. FIGS. 5 and 6 show the first five cycles at C/10 followed immediately by the 100 cycles at 1 C (left) as well as just the 1 C cycles normalized to the first cycle. The first five cycles at the lower charging rate are indicative of the maximum discharge capacity that can be obtained from the material where as the trajectory and final capacity after the 100 cycles at 1 C indicate the capacity retention upon repeated aggressive cycling. This data demonstrates that the discharge capacity of NMC811 produced by the carbonates method and the nitric acid metal method are within error of each other and that the capacity retention after 100 cycles at 1 C is slightly lower for the nitric acid metal method than the standard-carbonates method. In FIGS. 5 and 6 the 1 C cycling testing regime for cells made with NMC811 produced from the standard-carbonates method and the HNO₃-metal method. FIG. 5 shows full testing profile including the five conditioning cycles at C/10 and the 100 cycles at 1 C. FIG. 6 shows the 1 C cycling trajectory normalized to the capacity of the first 1 C cycle. The XRD pattern is provide in FIG. 7 wherein scan A is for the NMC 811 made with the nickel nitrate process and scan B used the carbonate digestion process. The performances as a cathode in a 2032 half cell are illustrated graphically in FIG. 8.

The data confirms formation of a similar CAM by the two methods.

### Nitric Acid Preparation

9.16M nitric acid solution is prepared by measuring 145 mL concentrated (15.8M) nitric acid into a 250 mL volumetric flask and diluting to the 250 mL mark. This solution is allowed to cool and topped up to the mark again.

### Ni Digestion

19.564 g (0.3333 mol) BHP Ni metal powder is placed into a 500 mL Erlenmeyer flask with a 1″ stir bar and placed on a stir plate and set to 200 rpm. Slowly, by pipette, the nitric acid is added to the Erlenmeyer flask taking care to avoid adding the nitric acid too fast and the subsequent generation of brown fumes (indicating NO₂). If the addition rate is correct then the fumes should be clear after the first 20 mL has been added. The Ni will be completely dissolved within 30 minutes and is then left to stir overnight to cool. The Ni solution should be a very dark green solution that is transparent when a bright light is shone through it.

### Ni Addition

84.11 g oxalic acid dihydrate (0.6672 mol) and 125 mL deionized water is placed in a 1 L beaker with a 3″ stirbar and set to stir at 400 rpm. Using a peristaltic pump and ⅛″ inner diameter silicone tubing, the Ni solution is added to the oxalic acid over 40 minutes (Huiyu pump setting=10). Upon addition to the concentrated oxalic acid the Ni precipitates as nickel oxalate. The reaction mixture will be an opaque turquoise slurry.

Li₂CO₃, Mn, and Co Addition

16.163 g Li₂CO₃ (0.4376 mol), 2.291 g Mn metal powder (0.0417 mol), and 2.458 g Co metal powder (0.0417 mol), and 30 mL deionized water are added to a 150 mL beaker with a 1″ stir bar and set to stir at 1000 rpm to form a slurry. Using a peristaltic pump and ⅛″ inner diameter silicone tubing, the slurry is added to the reaction mixture over 15 minutes (Huiyu pump setting=10). Any remaining Co metal stuck to the stir bar after the slurry has finished pumping is washed off into the reaction mixture. The Li₂CO₃ reacts immediately, the Co metal reacts within minutes, and the Mn metal has completely reacted after 1 hour of stirring which can be verified by interrupting stirring and checking if any metals settle out. The result is a blue slurry that is only a slightly lighter shade of turquoise than before the slurry addition. The reaction mixture is then allowed to stir overnight.

### Finishing Precursor Synthesis

The reaction mixture is the spray dried to yield 79.12 g fine light turquoise powder.

### NMC811 Synthesis Calcination

18 g of oxalate precursors are placed in two alumina saggars and calcined in a tube furnace under 0.76 L oxygen per minute according to the following temperature profile: ramp up from room temperature to 120° C. over 20 minutes and hold for 1 hour, ramp up from 143° C. to 830° C. over 142 minutes and hold for 15 hours, ramp down to 550° C. over 1 hour then continue to ramp down to 120° C. for 3 hours. The tube furnace is then allowed to passively cool until below 100° C. at which point the resulting NMC811 is removed, ground in an agate mortar and pestle and sieved through 325 mesh, and finally sealed in an aluminum vacuum bag and stored in a dessicator.

The invention has been described with reference to the preferred embodiments without limit thereto. One of skill in the art would realize additional embodiments and improvements which are not specifically set forth herein but which are within the scope of the invention as more specifically set forth in the claims appended hereto.

Claimed is:

1. A method of forming a lithium ion cathode material comprising:
reacting elemental metal with a multi-carboxylic acid to form an oxide precursor; and
heating said oxide precursor to form said lithium ion cathode material.

2. The method of forming a lithium ion cathode material of claim 1 wherein said elemental metal is selected from the group consisting of Li, Mn, Ni, Co, Al and Fe.

3. The method of forming a lithium ion cathode material of claim 2 wherein said elemental metal comprises at least two metals selected from the group consisting of Mn, Ni, Co and Al.

4. The method of forming a lithium ion cathode material of claim 2 wherein said elemental metal comprises at least two metals selected from the group consisting of Mn, Co and Al.

5. The method of forming a lithium ion cathode material of claim 4 further comprising reacting elemental Ni with nitric acid to form nickel nitrate.

6. The method of forming a lithium ion cathode material of claim 5 wherein said elemental nickel has no more than 0.05 wt % sulfur.

7. The method of forming a lithium ion cathode material of claim 5 further comprising reacting said nickel nitrate with said multi-carboxylic acid.

8. The method of forming a lithium ion cathode material of claim 1 wherein said multi-carboxylic acid is selected from the group consisting of oxalic acid, malonic acid, succinic acid, glutaric acid, adipic acid, citric acid, lactic acid, oxaloacetic acid, fumaric acid and maleic acid.

9. The method of forming a lithium ion cathode material of claim 8 wherein said multi-carboxylic acid is oxalic acid.

10. The method of forming a lithium ion cathode of claim 1 wherein said lithium ion cathode material is defined by the Formula I:
LiNiₓMn_{y}Co_{z}EₑO₄ Formula I
wherein E is a dopant;
x+y+z+e=2; and
0≤e≤0.2

11. The method of forming a lithium ion cathode of claim 10 wherein said Formula I is in a spinel crystalline form.

12. The method of forming a lithium ion cathode of claim 10 wherein neither x nor y are zero.

13. The method of forming a lithium ion cathode of claim 12 wherein said lithium ion cathode material is LiNi_{0.5}Mn_{1.5}O₄.

14. The method of forming a lithium ion cathode of claim 10 wherein said lithium ion cathode material is defined by the formula LiNiₓMn_{y}O₄ wherein 0.5≤x≤0.6 and 1.4≤y≤1.5.

15. The method of forming a lithium ion cathode of claim 14 wherein said 0.5≤x≤0.55 and 1.45≤y≤1.5.

16. The method of forming a lithium ion cathode of claim 10 wherein said lithium ion cathode material has a molar ratio of Mn to Ni of no more than 3.

17. The method of forming a lithium ion cathode of claim 16 wherein said lithium ion cathode material has a molar ratio of Mn to Ni of at least 2.33 to less than 3.

18. The method of forming a lithium ion cathode of claim 17 wherein said lithium ion cathode material has a molar ratio of Mn to Ni of at least 2.64 to less than 3.

19. The method of forming a lithium ion cathode of claim 10 wherein said dopant is selected from the group consisting of Al, Gd, Ti, Zr, Mg, Ca, Sr, Ba, Mg, Cr Fe, Cu, Zn, V, Bi, Nb and B.

20. The method of forming a lithium ion cathode of claim 19 wherein said dopant is selected from the group consisting of Al and Gd.

21. The method of forming a lithium ion cathode of claim 1 wherein said lithium ion cathode material is defined by the Formula II:
LiNiₐMn_{b}X_{c}G_{d}O₂ Formula II
wherein G is a dopant;
X is Co or Al;
wherein a+b+c+d=1; and
0≤d≤0.1.

22. The method of forming a lithium ion cathode of claim 21 wherein 0.5≤a≤0.9.

23. The method of forming a lithium ion cathode of claim 22 wherein 0.58≤a≤0.62 or 0.78≤a≤0.82.

24. The method of forming a lithium ion cathode of claim 21 wherein a=b=c.

25. The method of forming a lithium ion cathode of claim 1 wherein said heating is in air.

26. A battery comprising the lithium metal oxide made of the method of claim 1.

27. A method of forming a lithium ion cathode material comprising:
reacting element nickel with nitric acid to form nickel nitrate;
reacting said nickel nitrate with a multi-carboxylic acid to form an oxide precursor; and
heating said oxide precursor to form said lithium ion cathode material.

28. The method of forming a lithium ion cathode material of claim 27 wherein said elemental nickel has no more than 0.05 wt % sulfur.

29. The method of forming a lithium ion cathode material of claim 27 further comprising reacting an element metal with said multi-carboxylic acid to form a metal carboxylic salt wherein said elemental metal is selected from the group consisting of Mn, Co and Al.

30. The method of forming a lithium ion cathode material of claim 29 wherein said elemental metal comprises at least two metals selected from the group consisting of Mn, Co and Al.

31. The method of forming a lithium ion cathode material of claim 27 wherein said multi-carboxylic acid is selected from the group consisting of oxalic acid, malonic acid, succinic acid, glutaric acid, adipic acid, citric acid, lactic acid, oxaloacetic acid, fumaric acid and maleic acid.

32. The method of forming a lithium ion cathode material of claim 31 wherein said multi-carboxylic acid is oxalic acid.

33. The method of forming a lithium ion cathode of claim 27 wherein said lithium ion cathode material is defined by the Formula I:
LiNiₓMn_{y}Co_{z}EₑO₄ Formula I
wherein E is a dopant;
x+y+z+e=2; and
0≤e≤0.2

34. The method of forming a lithium ion cathode of claim 32 wherein said Formula I is in a spinel crystalline form.

35. The method of forming a lithium ion cathode of claim 33 wherein neither x nor y are zero.

36. The method of forming a lithium ion cathode of claim 35 wherein said lithium ion cathode material is LiNi_{0.5}Mn_{1.5}O₄.

37. The method of forming a lithium ion cathode of claim 33 wherein said lithium ion cathode material is defined by the formula LiNiₓMn_{y}O₄ wherein 0.5≤x≤0.6 and 1.4≤y≤1.5.

38. The method of forming a lithium ion cathode of claim 37 wherein said 0.5≤x≤0.55 and 1.45≤y≤1.5.

39. The method of forming a lithium ion cathode of claim 33 wherein said lithium ion cathode material has a molar ratio of Mn to Ni of no more than 3.

40. The method of forming a lithium ion cathode of claim 39 wherein said lithium ion cathode material has a molar ratio of Mn to Ni of at least 2.33 to less than 3.

41. The method of forming a lithium ion cathode of claim 40 wherein said lithium ion cathode material has a molar ratio of Mn to Ni of at least 2.64 to less than 3.

42. The method of forming a lithium ion cathode of claim 33 wherein said dopant is selected from the group consisting of Al, Gd, Ti, Zr, Mg, Ca, Sr, Ba, Mg, Cr Fe, Cu, Zn, V, Bi, Nb and B.

43. The method of forming a lithium ion cathode of claim 42 wherein said dopant is selected from the group consisting of Al and Gd.

44. The method of forming a lithium ion cathode of claim 27 wherein said lithium ion cathode material is defined by the Formula II:
LiNiₐMn_{b}X_{c}G_{d}O₂ Formula II
wherein G is a dopant;
X is Co or Al;
wherein a+b+c+d=1; and
0≤d≤0.1.

45. The method of forming a lithium ion cathode of claim 44 wherein 0.5≤a≤0.9.

46. The method of forming a lithium ion cathode of claim 45 wherein 0.58≤a≤0.62 or 0.78≤a≤0.82.

47. The method of forming a lithium ion cathode of claim 44 wherein a=b=c.

48. The method of forming a lithium ion cathode of claim 27 wherein said heating is in air.

49. A battery comprising the lithium metal oxide made by the method of claim 27.
